(19) United States
(12) Patent Application Publication
(10) Pub. No.: US 2017/0285669 A1
(43) Pub. Date: Oct. 5, 2017

(54) THERMOSTATIC WORKING ELEMENT

(71) Applicant: Mahle International GmbH, Stuttgart (DE)

(72) Inventors: Harald Ruoff, Kornwestheim (DE); Martin Holzhauser, Auenwald (DE); Joerg Bergschneider, Stuttgart (DE)

(21) Appl. No.: 15/476,923

(22) Filed: Mar. 31, 2017

(30) Foreign Application Priority Data
Apr. 1, 2016 (DE) 10 2016 205 458.9

(51) Int. Cl. G05D 23/02; G05D 23/22; F01P 7/16

(52) U.S. Cl. CPC G05D 23/02; F01P 7/16; G05D 23/22; F01P 7/167; F01P 2007/146

(57) ABSTRACT

A thermostatic working element may include a cup-shaped housing having a housing jacket and a housing base, the housing containing a working chamber in which an expansion material may be located. The working element may also include an axially adjustable working piston projecting into the working chamber through a piston opening in the housing base, a cover closing a housing opening lying axially opposite the housing base, an annular seal surrounding the working piston and lying radially thereagainst, and an axial guide in a region of the housing base and surrounding and axially guiding the working piston. The annular seal may be axially in contact on a rear end side of the annular seal facing away from the housing base with the expansion material. The annular seal may lie radially against the housing jacket.

### CROSS-REFERENCE TO RELATED APPLICATIONS

This application claims priority to German Application No. DE 10 2016 205 458.9 filed on Apr. 1, 2016, the contents of which are hereby incorporated by reference in its entirety.

### TECHNICAL FIELD

The present invention relates to a thermostatic working element, in particular for a thermostatic valve. The invention also relates to a thermostatic valve which is equipped with a working element of this type, in particular for a cooling circuit of an internal combustion engine, preferably in a motor vehicle.

### BACKGROUND

EP 0 165 395 A2 discloses a thermostatic valve for a cooling circuit of an internal combustion engine, said thermostatic valve being equipped with a thermostatic working element for actuating valve members. The thermostatic valve serves to split a coolant flow, which comes from the internal combustion engine, depending on the temperature of said coolant flow between a first outlet leading back to the internal combustion engine via a radiator of the cooling circuit and a second outlet leading directly back to the internal combustion engine bypassing the radiator. The temperature-dependent actuation or adjustment of the valve members for controlling said splitting of the coolant flow which is supplied takes place with the aid of the thermostatic working element.

A thermostatic working element to be used here is known, for example, from EP 1 811 277 A2. The known working element has a cylindrical housing which is open on both axial sides and which contains a working chamber in which an expansion material is located. Furthermore, an axially adjustable working piston is provided which projects into the working chamber. A cup-shaped guide element, the base of which is penetrated by the working piston, is inserted into the housing. An annular seal is arranged in the guide element, said annular seal surrounding the working piston and lying radially on the inside against the working piston and radially on the outside against a cylindrical wall of the guide element. Furthermore, the seal lies axially firstly against the base of the guide element and lies axially secondly against an annular disc which is penetrated by the working piston and which closes the interior of the guide element in which the seal is arranged. Axially opposite the guide element, the housing is closed by means of a base. The production of the known working element is comparatively complicated because of the many individual parts.

### SUMMARY

The present invention is concerned with the problem of specifying, for such a thermostatic working element or for a thermostatic valve equipped therewith, an improved embodiment or at least another embodiment which is distinguished in particular by simplified producibility.

This problem is solved according to the invention by the subject matter of the independent claim. Advantageous embodiments are the subject matter of the dependent claims.

The invention is based on the general concept of configuring the housing to be cup-shaped such that it has a cylindrical housing jacket and a housing base which is formed integrally on the latter and is penetrated by the working piston. The cup-shaped housing is therefore produced with housing jacket and housing base from a single metal piece, preferably by deformation, in particular by deep drawing. Furthermore, an axial guide is provided on the housing for the working piston which is adjustable axially relative to the housing, said axial guide being penetrated by the working piston and axially guiding the working piston for its axial adjustment relative to the housing. In addition, an annular seal is provided which is likewise penetrated by the working piston and which is also geometrically configured and arranged in the housing in such a manner that it lies radially on the inside directly against the working piston, lies radially on the outside directly against the housing jacket, lies axially firstly directly against the axial guide or against the guide ring and is exposed axially secondly directly to the expansion material. The seal is therefore located axially between the expansion material and the axial guide which considerably simplifies the construction and the production of the working element.

At the same time, optimum longitudinal guidance for the working piston relative to the housing can be achieved with the aid of the axial guide. In particular, for this purpose, the axial guide defines, radially on the inside, a cylindrical guide contour which interacts with the working piston for the longitudinal guidance thereof. It can expediently then be provided that an axial guide length of said guide contour is greater than an outside diameter of the working piston or as a free inside diameter of the guide contour. By this means, particularly efficient and stable longitudinal guidance for the working piston is realized.

It can advantageously be provided that the seal by its rear end side axially bounds the working chamber. As a consequence, no further component is required axially between the seal and the working chamber filled with expansion material.

An embodiment is preferred in which the axial guide is formed by a separate guide ring which is inserted into the housing, is supported axially on the housing base and is positioned radially by the housing jacket. In this case, it can now be provided in particular that the seal lies axially on its front end side facing the housing base against the guide ring. The realization of the axial guide by means of a guide ring which is separate with respect to the housing simplifies the production of the housing. Furthermore, the material of the guide ring can be adapted more simply tribologically to the material of the working piston than the material of the housing.

In an advantageous development, the guide ring can be fixed axially in the housing by an interference fit. At the same time, centring of the working piston relative to the housing is realized by the interference fit. In addition, the interference fit can bring about a sufficiently tight contact connection between guide ring and housing jacket.

Alternatively to such a separate guide ring, it can also be provided that the axial guide is formed by a guide sleeve which is arranged fixedly on the housing base on an outer side facing away from the working chamber and forms a surround of the piston opening. In this case, the seal can lie axially on its front end side facing the housing base against the housing base. Said guide sleeve can be added onto the housing and connected fixedly and permanently thereto, for example via a welded joint. However, it is preferred that the guide sleeve is formed by an axial portion of the housing that is formed integrally on the housing base. By this means, the guide sleeve can be formed on the housing in a manner coordinated with the material thereof during the production of the housing. For example, the guide sleeve can be integrally formed on the housing during the deep drawing of same.

According to an advantageous embodiment, the cover can have a cylindrical portion which projects axially into the housing jacket and in the process fills the housing opening. The insertion depth of this cylindrical portion into the housing jacket makes it possible to define the volume of the working chamber that is provided for receiving the expansion material. A calibration of the working element can therefore be carried out in particular during the assembly by varying the insertion depth of the cylindrical portion into the housing.

The cover is fixedly connected to the housing. After the abovementioned calibration, in which the optimum insertion depth of the cover is determined, the cover is preferably connected fixedly and permanently to the housing. This can be undertaken, for example, with a welded joint, preferably by laser welding.

The cover can preferably have a functional structure on a side facing away from the housing. Said functional structure can form, for example, a resetting device and/or part of a valve device. This construction has the advantage that the working element can be adapted to different applications by appropriate modifications of the cover while the housing with guide ring, seal, working piston and expansion material can otherwise be formed in a structurally identical manner. The formation of variants for the working element is therefore simplified. For example, the working element can thereby be adapted in a simple and cost-effective manner to various thermostatic valves.

According to an advantageous development, the functional structure can have a shaft protruding axially from the rest of the cover, an annular disc arranged on the shaft in an axially adjustable manner, and a spring supporting the annular disc on the rest of the cover. Furthermore, it can expediently be provided that the spring prestresses the annular disc against an axial stop formed on the shaft. For example, the annular disc can represent a valve disc of a disc valve, the valve seat of which is formed on another component, for example in a valve housing into which the working element is fitted.

In another embodiment, the seal can have, radially on the inside, two sealing lips which lie radially directly against the working piston in a manner spaced apart from each other axially. This realizes a highly efficient seal in order to avoid the expansion material from escaping out of the housing along the working piston.

In another embodiment, the seal can be configured conically radially on the outside, wherein said seal expediently tapers in the direction of the housing base. This construction simplifies the mounting of the seal. At the same time, an axial fixing, sufficient at least for the assembly, of the guide ring in the housing can be realized as a result.

In another embodiment, the housing can have, in an axial first end region containing the housing base, a first outer cross section which is smaller than a second outer cross section which the housing has in an axial second end region containing the housing opening. This can be used, for example, to be able to more easily attach an add-on part to the housing.

The first end region can expediently contain the guide ring. By this means, the guide ring can be dimensioned to be smaller radially, as a result of which it can be produced at a more reasonable cost.

According to an advantageous development, the first end region can now be produced by a deformation reducing the outer cross section of the housing and for compressing the guide ring. The centring and axial fixing of the guide ring in the housing can thereby be realized in a comparatively simple, reasonably priced and reliable manner.

The first end region can expediently contain the seal. In particular in conjunction with the abovementioned deformation for compressing the guide ring, the radial prestress between seal and housing jacket can be increased when the seal is arranged in the first end region.

Additionally or alternatively, it can be provided that the second end region contains the expansion material. By this means, a comparatively large volume is available for the expansion material.

An embodiment is particularly expedient in which the first end region merges directly into the second end region, and therefore, apart from the transition, no additional intermediate region is included. The housing therefore has a comparatively simple construction.

In another embodiment, a valve disc can be fixed axially on the housing. In particular, the valve disc can be fixed axially on the housing jacket by an interference fit, which simplifies the production. Alternatively, any other suitable fastening techniques for fixing the valve disc to the housing can also be realized, for example laser welding, securing rings and the like. With the valve disc attached to the housing, the working element can be used, for example, for adjusting the valve disc relative to a valve seat which is formed in a valve which is equipped with the working element.

A thermostatic valve according to the invention which is suitable in particular for a cooling circuit of an internal combustion engine is equipped with a valve housing which has an inlet, a first outlet and a second outlet. In addition, the thermostatic valve is equipped with a thermostatic working element of the above-described type which serves in the thermostatic valve for controlling splitting of a fluid flow, which is supplied to the inlet, between the first outlet and the second outlet. The working element is arranged here in the valve housing in such a manner that the fluid flow flows around the housing of the working element and assumes the temperature of said working element. Since the volume of the expansion material changes depending on the temperature, this results in an axial adjustment movement of the working piston, which adjustment movement can be used for adjusting valve members which, for their part, bring about the control of the splitting of the flow between the two outlets depending on the temperature of the fluid flow.

The working piston can expediently be supported on the valve housing. Additionally or alternatively, the abovementioned valve disc which is fixed on the housing can interact with a first valve seat, which is formed on the valve housing, for controlling the first outlet. Additionally or alternatively, the abovementioned annular disc which is arranged on the cover can interact as a further valve disc with a second valve seat, which is formed on the valve housing, for controlling the second outlet.

The working element is preferably produced in such a manner that, during the production of the working element, the expansion material is inserted as a single-part or multi-part solid body produced from powder by press moulding into the working chamber. Such solid bodies produced by press moulding can also be referred to as “pellets”. The use of a solid body during the production of the working element simplifies the handling of the expansion material. By dispensing with pouring in the expansion material in liquid form, less energy is required to introduce the required amount of expansion material into the working chamber. With appropriate shaping of the solid body, the calibration of the working element, i.e. the finding of an optimum axial positioning of the cover relative to the housing, is also simplified. If the cover is inserted with an axial portion axially into the housing opening, the optimum axial relative position between cover and housing is produced as soon as the cover comes to lie axially against the solid body inserted into the housing beforehand. The optimum relative position found in this manner can then be kept by suitable fixing of the cover to the housing.

When the thermostatic valve is used in a cooling circuit of an internal combustion engine which can be arranged in particular in a vehicle, the inlet of the valve housing is connected to a coolant outlet of the internal combustion engine. The first outlet of the valve housing is then connected to a radiator inlet of a radiator of the cooling circuit. A radiator outlet of said radiator is then connected to a coolant inlet of the internal combustion engine. The first outlet therefore leads back via the radiator to the internal combustion engine. The second outlet is connected to the coolant inlet of the internal combustion engine directly or bypassing the radiator. Bypassing the radiator, the second outlet therefore leads in particular directly back to the internal combustion engine.

Further important features and advantages of the invention emerge from the dependent claims, from the drawings and from the associated description of the figures with reference to the drawings.

It goes without saying that the features mentioned above and those which have yet to be explained below can be used not only in the respectively stated combination but also in other combinations or on their own without departing from the scope of the present invention.

Preferred exemplary embodiments of the invention are illustrated in the drawings and are explained in more detail in the description below, wherein the same reference signs refer to identical or similar or functionally identical components.

### BRIEF DESCRIPTION OF THE DRAWINGS

In the drawings, in each case schematically,

FIG. 1 shows a longitudinal section of a thermostatic working element in a first embodiment,

FIG. 2 shows a longitudinal section of the working element as in FIG. 1, but in a second embodiment,

FIG. 3 shows a greatly simplified longitudinal section of a thermostatic valve which contains such a working element according to the second embodiment shown in FIG. 2.

### DETAILED DESCRIPTION

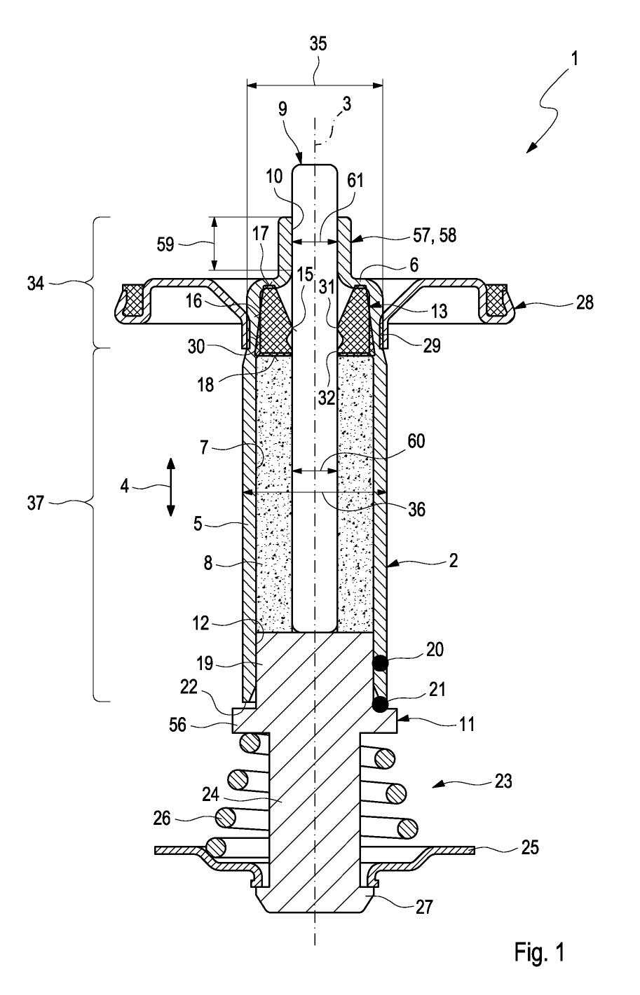

According to FIGS. 1, 2 and 3, a thermostatic working element 1 comprises a cup-shaped housing 2 which has a longitudinal centre axis 3. The longitudinal centre axis 3 here defines an axial direction 4 which runs parallel to the longitudinal centre axis 3. The housing 2 has a cylindrical housing jacket 5 and a housing base 6. Furthermore, the housing 2 contains a working chamber 7 in which an expansion material 8, for example a wax, is located.

In addition, the working element 1 has a working piston 9 which is adjustable axially relative to the housing 2 and which projects into the working chamber 7 through a central piston opening 10 formed in the housing base 6. Furthermore, the working element 1 is equipped with a cover 11 which closes a housing opening 12 which the housing 2 has axially opposite the housing base 6. The working chamber 7 is therefore closed by the cover 11.

Furthermore, the working element 1 has an annular seal 13 and an axial guide 57. The axial guide 57 surrounds the working piston 9 in the circumferential direction and guides the working piston 9 axially. The seal 13 is configured in such a manner that it surrounds the working piston 9 in the circumferential direction. Furthermore, the seal 13 lies radially on the inside on its inner side 15 directly against the working piston 9, while said seal lies radially on the outside on its outer side 16 directly against the housing jacket 5. With its rear end side 18 facing away from the housing base 6, the seal 13 is directly in contact axially with the expansion material 8.

The cover 11 has a cylindrical portion 19 which enters axially into the housing jacket 5 and in the process fills and closes the housing opening 12. When the working element 1 is calibrated, the volume of the working chamber 7 can be adjusted during the assembly by varying the axial insertion depth of the cylindrical portion 19 into the housing jacket 5. The axial position, which is found by the calibration, between housing 2 and cover 11 can then be permanently secured by suitable fixing. For example, a welding point 20 can be provided in order to fix the axial position between cover 11 and housing 2. The welding point 20 is mounted here on the housing jacket 5 in the region of the cylindrical portion 19. For the tight closing of the housing 2 and for the final fixing of the cover 11 on the housing 2, an encircling weld seam 21 can also be provided which, in the example, is formed in the region of an end-side edge 22, which faces away from the housing base 6, of the housing jacket 5 and is only indicated on the right side in the figures.

In the examples shown, an axial gap can be formed axially between the end-side edge 22 and a radially protruding, encircling collar 56 of the cover 11 if, during the calibration, the axial position between housing 2 and cover 11 has been found. This axial gap can be closed or bridged by the encircling weld seam 21.

Alternatively, it is also possible to insert the cover 11 into the housing 2 until contact is made, wherein then, for example, said collar 56 and said edge 22 as an axial stop can interact. The volume of the working chamber 7 can subsequently be calibrated in a conventional manner by specific deformation of the housing jacket 5.

In the case of the examples shown here, the cover 11 is also equipped with a functional structure 23 on a side facing away from the housing 2. In the example, the functional structure 23 forms part of a valve device with an integrated resetting and/or prestressing device. In detail, the functional structure 23 has a shaft 24 protruding axially from the rest of the cover 11, an annular disc 25 arranged in an axially adjustable manner on the shaft 24, and a spring 26 which is supported axially on the annular disc 25 and on the rest of the cover 11. Furthermore, the spring 26 prestresses the annular disc 25 here against an axial stop 27 which is integrally formed here on the shaft 24. The annular disc 25 can be configured here as a valve disc.

In the examples shown here, a valve disc 28 is fixed axially on the housing 2, for example by means of an interference fit 29. For this purpose, the housing 2 with its housing jacket 5 penetrates a central opening 30 of the valve disc 28, the edge of which opening is subsequently deformed in such a manner that its opening width is reduced. The valve disc 28 formed on the housing 2 is referred to below as first valve disc 28. The annular disc 25 which is preferably configured as a valve disc and is located on the cover 11 is referred to below as second valve disc 25. Accordingly, in the preferred example, the working element 1 here has two valve discs, namely the first valve disc 28 fixed axially on the housing 2 and the second valve disc 25 held in an axially adjustable manner on the cover 11.

The seal 13 has, on its inner side 15, two sealing lips 31, 32 which are spaced apart axially from each other and, in each case radially on the inside, lie radially directly against the working piston 9. By this means, a two-stage seal in relation to the expansion material 8 is realized. The outer side 16 of the seal 13 is configured conically here in such a manner that the conical outer side 16 tapers in the direction of the housing base 6.

The housing 2 expediently therefore has, in an axial first end region 34 containing the housing base 6, a first outer cross section 35 which is smaller than a second outer cross section 36 which the housing 2 has in an axial second end region 37 containing the housing opening 12. The first end region 34 expediently contains the axial guide 57 and optionally also the seal 13. The first end region 34 can be produced by a deformation reducing the outer cross section of the housing 2. The second end region 37 expediently directly adjoins the first end region 34 and contains the expansion material 8.

In the example shown, the cover 11 has the radially protruding collar 56 which is already mentioned above, encircles in a closed manner in the circumferential direction and, in the example shown, is welded to the end-side edge 22 with the aid of the weld seam 21. The collar 56 is located on the cover 11 axially between the centrally axially protruding axial portion 19 on the one hand, and the centrally axially protruding shaft 24 on the other hand. The spring 26 is supported axially on the collar 56.

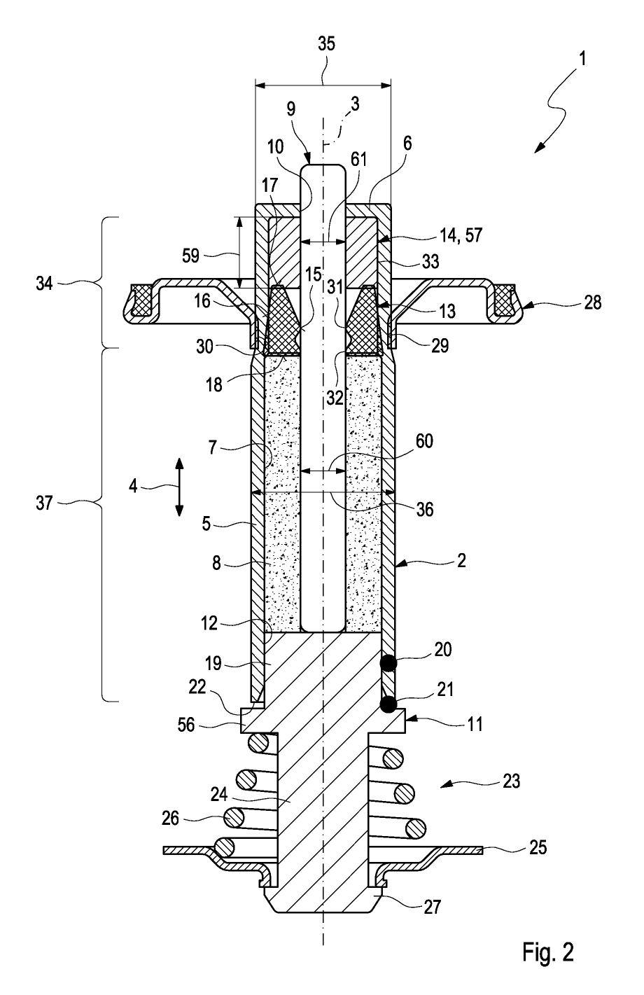

The two embodiments of FIGS. 1 and 2 differ only by the configuration of the axial guide 57. In the case of the first embodiment shown in FIG. 1, the axial guide 57 is formed by a guide sleeve 58 which is fixedly arranged on the housing base 6 on an outer side facing away from the working chamber 7. The guide sleeve 58 here forms a surround of the piston opening 10. In this case, the seal 13 is supported on its front end side 17 facing the housing base 6 directly on the housing base 6. Said guide sleeve 58 can basically be added onto the housing 2 and connected fixedly and permanently thereto, for example via a welded joint. However, the embodiment shown here is preferred in which the guide sleeve 58 is formed by an axial portion of the housing 2 that is formed integrally on the housing base 6. By this means, the guide sleeve 58 can be formed on the housing 2 in a manner coordinated with the material thereof during the production of the housing 2. For example, the guide sleeve 58 can be integrally formed on the housing 2 during the deep drawing of same.

In the case of the second embodiment shown in FIG. 2, the axial guide 57 is formed by a separate guide ring 14 which is inserted into the housing 2, is supported axially on the housing base 6 and is positioned radially by the housing jacket 5. In this case, the seal 13 is axially supported on its front end side 17 facing the housing base 6 directly on the guide ring 14. The realization of the axial guide 57 by means of a guide ring 14 which is separate with respect to the housing 2 simplifies the production of the housing 2. Furthermore, the material of the guide ring 14 can be adapted more simply tribologically to the material of the working piston 9 than the material of the housing 2.

In the example of FIG. 2, the guide ring 14 is fixed axially in the housing 2 by an interference fit 33. By means of the interference fit 33, centring of the working piston 9 relative to the housing 2 is realized at the same time. In addition, the interference fit 33 can bring about a sufficiently tight contact connection between guide ring 14 and housing jacket 5. Said interference fit 33 can be realized, for example, by a deformation of the housing 2 reducing the cross section of the housing jacket 5 in the region of the guide ring 14.

As mentioned, the guide ring 14 is a separate component with respect to the housing 2, which component is inserted into the housing 2. The guide ring 14 is positioned in the housing 2 in such a manner that the guide ring 14 is supported axially directly on the housing base 6 and is surrounded radially by the housing jacket 5. The guide ring 14 can preferably be supported directly on the housing jacket 5.

According to FIGS. 1 and 2, the axial guide 57, irrespective of whether it is now formed by the guide sleeve 58 or the guide ring 14, defines a guide contour which is in contact with the working piston 9 in order to axially guide the latter during its axial adjustment relative to the housing 2. It is expediently now provided that an axial guide length 59 of said guide contour is greater than an outside diameter 60 of the working piston 9 or than a free inside diameter 61 of the guide contour. In the example of FIG. 1, the guide sleeve 58 has this guide length 59, whereas, in the example of FIG. 2, the guide ring 14 has this guide length 59.

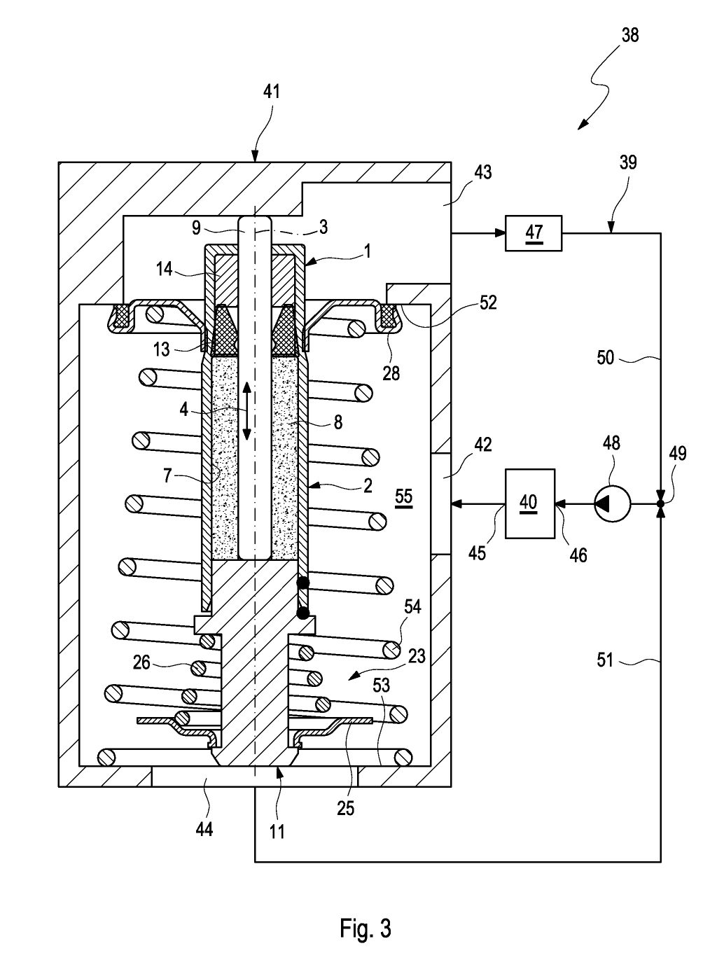

According to FIG. 3, a thermostatic valve 38 which is connected into a cooling circuit 39 of an internal combustion engine 40 comprises a thermostatic working element 1 of the above-described type and a valve housing 41 in which the working element 1 is arranged. In the example of FIG. 3, the working element 1 is used according to the second embodiment shown in FIG. 2. It is clear that, instead, the working element 1 can also be used according to the first embodiment shown in FIG. 1. The valve housing 41 has an inlet 42, a first outlet 43 and a second outlet 44. The working element 1 serves for the temperature-dependent control of splitting a fluid flow, which is supplied to the inlet 42, between the first outlet 43 and the second outlet 44. The valve housing 41 is connected into the cooling circuit 39 in such a manner that the inlet 42 is connected to a coolant outlet 45 of the internal combustion engine 40 while the first outlet 43 and the second outlet 44 are connected to a coolant inlet 46 of the internal combustion engine 40. The first outlet 43 leads here via a radiator 47 of the cooling circuit 39 to the internal combustion engine 40 while the second outlet 44 leads to the internal combustion engine 40 bypassing the radiator 47. Furthermore, the cooling circuit 39 has a coolant pump 48 and a connecting point 49 which combines a first branch 50 of the cooling circuit 39, said branch coming from the first outlet 43 and containing the radiator 47, with a second branch 51 of the cooling circuit 39, said branch coming from the second outlet 44, specifically upstream of the coolant pump 48.

The working piston 9 is supported axially on the valve housing 41. The first valve disc 28 formed on the housing 2 interacts with a first valve seat 52 in order to control the first outlet 43. FIG. 3 shows a closed position of the first valve disc 28 in which the first outlet 43 is blocked. The first valve seat 52 here is formed directly on the valve housing 41. The second valve disc 25 which is arranged on the cover 11 interacts with a second valve seat 53 in order to control the second outlet 44. In the example of FIG. 3, the second valve disc 25 is in an open position, and therefore the second outlet 44 is open. The second valve seat 53 is likewise formed here directly on the valve housing 41. Furthermore, a resetting spring 54 is indicated in FIG. 3, said resetting spring prestressing the first valve disc 28 into its closed position. For this purpose, the resetting spring 54 is supported axially firstly on the first valve disc 28 and is supported axially secondly on the valve housing 41.

The thermostatic valve 38 presented here operates as follows: during a cold start of the internal combustion engine 40, the coolant is at ambient temperature, i.e. is comparatively cold. The working element 1 is in the state which is shown in FIG. 3 and in which the first outlet 43 is blocked while the second outlet 44 is open. As a consequence, the coolant flows through the inlet 42 into a distributor chamber 55 of the valve housing 41, in which the working element 1 is located. In the process, the coolant flows around the housing 2, and therefore the expansion material 8 assumes the temperature of the coolant. The coolant flows through the second outlet 44 directly back to the internal combustion engine 40 bypassing the radiator 47. If the internal combustion engine 40 heats up, the temperature of the coolant also increases. As a consequence, the expansion material 8 also heats up. As the temperature increases, the expansion material 8 expands, as a result of which the working piston 9 is increasingly pushed out of the working chamber 7. Since the working piston 9 is supported on the valve housing 41, this results in an axial adjustment of the housing 2 relative to the working piston 9 and therefore relative to the valve housing 41. As a consequence, the first valve disc 28 lifts increasingly off the first valve seat 52 while the second valve disc 25 increasingly approaches the second valve seat 53. As a consequence, coolant increasingly flows through the first outlet 43 via the radiator 47 to the internal combustion engine 40 while less and less coolant takes the path via the second outlet 44. If the coolant reaches a high temperature, the housing 2 is adjusted axially to such an extent that the second valve disc 25 reaches its closed position, i.e. lies against the second valve seat 53 and blocks the second outlet 44. As a consequence, all of the coolant flows through the first outlet 43 via the radiator 47 to the internal combustion engine 40.

1. A thermostatic working element, comprising:
a cup-shaped housing having a housing jacket and a housing base, the housing containing a working chamber in which an expansion material is located;
an axially adjustable working piston projecting into the working chamber through a piston opening in the housing base;
a cover closing a housing opening lying axially opposite the housing base;
an annular seal surrounding the working piston and lying radially thereagainst; and
an axial guide in a region of the housing base and surrounding and axially guiding the working piston;
wherein the annular seal is axially in contact on a rear end side of the annular seal facing away from the housing base with the expansion material; and
wherein the annular seal lies radially against the housing jacket.

2. The working element according to claim 1, wherein:
the axial guide is formed by a separate guide ring inserted into the housing, is supported axially on the housing base, and is positioned radially by the housing jacket; and
the annular seal lies axially on a front end side of the annular ring facing the housing base against the guide ring.

3. The working element according to claim 2, wherein the guide ring is fixed axially in the housing by an interference fit.

4. The working element according to claim 1, wherein:
the axial guide is formed by a guide sleeve formed on the housing base on an outer side facing away from the working chamber, and forms a surround of the piston opening; and
the annular seal lies axially on a front end side of the annular seal facing the housing base against the housing base.

5. The working element according to claim 4, wherein the guide sleeve is formed by an axial portion of the housing formed integrally on the housing base.

6. The working element according to claim 1, the cover having a cylindrical portion projecting axially into the housing jacket and filling the housing opening.

7. The working element according to wherein the cover is welded to the housing.

8. The working element according to claim 1, wherein the cover has a functional structure on a side facing away from the housing.

9. The working element according to claim 8, wherein the functional structure has a shaft protruding axially from a remainder of the cover, an annular disc arranged in an axially adjustable manner on the shaft, and a spring supporting the annular disc on the remainder of the cover.

10. The working element according to claim 9, wherein the spring prestresses the annular disc against an axial stop formed on the shaft.

11. The working element according to claim 1, wherein the annular seal has, radially on the inside, two sealing lips lying radially against the working piston in a manner spaced apart axially from each other.

12. The working element according to claim 1, wherein the annular seal is conical radially on the outside and tapers axially in a direction of the housing base.

13. The working element according to claim 1, wherein the housing has a first outer cross section in an axial first end region containing the housing base, and a second outer cross section in an axial second end region containing the housing opening, wherein the first outer cross section is smaller than the second outer cross section.

14. The working element according to, claim 13, wherein the first end region contains a guide ring inserted into the housing and is produced by a deformation reducing the outer cross section of the housing and is for compressing the guide ring, wherein the axial guide is formed by the guide ring.

15. The working element according to claim 13, wherein:
the first end region contains the annular seal; and
the second end region contains the expansion material.

16. The working element according to claim 13, wherein the first end region merges directly into the second end region.

17. The working element according to that claim 1 further comprising a valve disc fixed axially on the housing.

18. The working element according to claim 17, wherein the valve disc is fixed axially on the housing jacket by an interference fit.

19. The working element according to claim 1, wherein the expansion material is inserted as one of a single-part and a multi-part solid body produced from powder by press moulding into the working chamber.

20. A thermostatic valve comprising:
a valve housing having an inlet, a first outlet; and a second outlet; and
a thermostatic working element for controlling splitting of a fluid flow, which is supplied to the inlet, between the first outlet and the second outlet, the thermostatic working element having:
a cup-shaped housing having a housing jacket and a housing base, the housing containing a working chamber in which an expansion material is located;
an axially adjustable working piston projecting into the working chamber through a piston opening in the housing base;
a cover closing a housing opening lying axially opposite the housing base;
an annular seal surrounding the working piston and lying radially thereagainst; and
an axial guide in a region of the housing base and surrounding and axially guiding the working piston;
wherein the annular seal is axially in contact on a rear end side of the annular seal facing away from the housing base with the expansion material; and
wherein the annular seal lies radially against the housing jacket.

21. The working element according to claim 1, wherein the housing base is formed integrally on the housing jacket.

22. The working element according to claim 1, wherein the annular seal is arranged axially between the axial guide and the expansion material.

23. The working element according to claim 22, wherein the annular seal axially bounds the working chamber by the rear end side of the annular seal.
